(19) United States
(12) Patent Application Publication
(10) Pub. No.: US 2002/0073319 A1
(43) Pub. Date: Jun. 13, 2002

(54) Contents data supplying system capable of protecting copyright of contents effectively and method of supplying the same

(75) Inventor: Koji Manabe, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/007,922

(22) Filed: Dec. 7, 2001

(30) Foreign Application Priority Data
Dec. 7, 2000 (JP) 2000-372330

(51) Int. Cl. H04L 9/00

(52) U.S. Cl. 713/176

(57) ABSTRACT

In a contents data supplying system, the output device controller 10 obtains an ID of the printer 20 from the printer 20. The output device controller 10 then notifies the contents data supplying device 30 of the ID of the printer 20. The contents data supplying device 30 inserts an electronic watermarking information including the ID notified by the output device controller 10 into contents data hoped by a user who owns the printer 20 and the output device controller 10 to be buried therein. The contents data supplying device 30 then supplies the contents data having the electronic watermarking information buried therein to the output device controller 10 as electronically watermarked contents data The contents data hoped by a user will hereunder be called “original contents data” so as to be distinguished from deformed contents data, and the like. The output device controller 10 compares the ID as a part of the electronic watermarking information inserted in the electronically watermarked contents data with the above-mentioned ID obtained from the printer 20 to judge whether or not both are identical with each other. When the both IDs are identical with each other, the output device controller 10 deforms the electronically watermarked contents data and then produces printing data capable of being printed by the printer 20. The printing data are outputted from the output device controller 10 to the printer 20, so that the printing data are printed by the printer 20. In this embodiment, particularly, printer 20 investigates by itself whether or not the printing data have been completely printed. The printer 20 then notifies the output device controller 10 of the result of investigation as printing result information.

### BACKGROUND OF THE INVENTION

The present invention relates to a contents data supplying system and a method of supplying contents data, in particular to the contents data supplying system and the method of supplying contents data which is for use in protecting copyright of digital contents.

Conventionally, various proposals have been made about a method of protecting copyright of contents in printing operations using a printer

Such methods are exemplified in unexamined Japanese Patent Publications 2000-165652 (hereunder called as “first prior art”) and 2000-194832 (hereunder called as “second prior art”).

An object of the first prior art is protecting copyright of digital contents by adequately controlling print data, when the digital contents including an electronic watermark buried therein are printed by a printer. As a technique for achieving the object, it is proposed by the first prior art that the electronic watermark is extracted to be buried into a concentration value of an image, and that the image is then deformed by alteration processing of the concentration value, for example, addition of information to the concentration value, and so on.

On the other hand, in a technique proposed by the second prior art, when an object such as figures, characters, and the like is stored as data, additional information are buried into the data by electronic watermarking. Further, in the technique, another additional information is obtained from a user when data are outputted. Accordingly, it is judged whether or not the another additional information is different from the additional information having already buried into the data. As a result, in a case that the another additional information is different from the additional information, the data are prevented from being outputted.

Moreover, the other techniques using electronic watermarking related to the present invention are exemplified in unexamined Japanese Patent Publications Hei 11-239129 (hereunder called as “third prior art”), 2000-227756 (hereunder called as “fourth prior art”), and 2000-227757 (hereunder called as “fifth prior art”). A common object of the third through the fifth prior arts is “enabling a relation between electronic data and personal/organization to be admitted with higher reliability.” and “directly showing personals/organizations having relation with electronic data to a user through the electronic data in order that the personals/organizations capable of being admitted may be securely corresponding to the electronic data.” As means for achieving the object, a common technique is proposed by the third through the fifth prior arts. In the common technique, “A provider apparatus sends contents purchased by a purchaser in a code word by the use of the purchaser s public key.” “A purchaser apparatus makes an electronic signature of contents by the use of the purchaser's secret key and buries the electronic signature into the contents sent from the provider apparatus as an electronic watermark.” “When an unfair copy is obtained, the provider apparatus investigates the electronic signature of the electronic watermark. The provider apparatus thereby identifies a purchaser who purchased the source contents of the unfair copy.”

Furthermore, yet the other technique related to the present invention is exemplified in unexamined Japanese Patent Publication Hei 11-119651 (hereunder called as “sixth prior art”). An object of the technique proposed by the sixth prior art is to inseparably combine deleting a visible mark with burying an invisible mark, when the visible mark is deleted and the invisible mark is buried. In the technique, deleting the visible mark and burying the invisible mark are carried out in parallel with each other.

However, a copyright of contents is not always protected adequately, even though the techniques or methods proposed by the above-mentioned first through sixth prior arts are used.

For example, in the above-mentioned first through sixth prior arts, electronic watermarks inserted into contents are almost information inputted by a user or an user ID, which can be directly handled by the user. The user can therefore advise the third party of those information and ID ill intentionally. The third party that obtained the information or the ID sometimes can use the contents unfairly. Namely, unfair use of contents cannot be effectively prevented even in the above-mentioned first through sixth prior arts

### SUMMARY OF THE INVENTION

It is therefore an object of the present invention to provide contents data supplying system and a method of supplying contents data which are capable of protecting copyright of contents effectively.

Other objects of the present invention will become clear as the description proceeds.

According to an aspect of the present invention, there is provided a method of supplying contents data, said method comprising the steps of: firstly storing original contents data for original contents; secondly requesting a user who hopes a supply of said original contents data to input ID of an output device owned by the user; thirdly inserting electronic watermarking information including said ID inputted by the user into said original contents data to produce electronically watermarked contents data in accordance with a predetermined electronic watermarking method capable of being handled by an output device controller owned by the user; and fourthly supplying the user with said electronically watermarked contents data.

The electronic watermarking information inserted in the thirdly inserting step may be a visible mark formed on said original contents.

The original contents data may be image data.

The output device may be a printer and said original contents data may be data capable of being printed.

The fourthly supplying step may be carried out by transmitting said electronically watermarked contents data to said user through a network.

The fourthly supplying step may be carried out by storing said electronically watermarked contents data in a storing medium prepared by said user.

The method of supplying contents data may further comprise the step of conducting admittance processing using an electronic signature with said user to produce a common key co-owned with said user, wherein said fourthly supplying step is carried out by supplying said electronically watermarked contents data coded by said common key.

The method of supplying contents data may further comprise the steps of: previously storing a fee for using said original contents data, said fee being related to the original contents data; obtaining said fee related to said original contents data of which said user hopes a supply; and notifying said user of the obtained fee.

According to another aspect of the present invention, there is also provided a contents data supplying device comprising: a storing section which stores original contents data for original contents; an ID obtaining section which obtains ID of an output device owned by a user who hopes a supply of said original contents data; an electronic watermark inserting section which inserts electronic watermarking information including said ID obtained by said ID obtaining section into said original contents data to produce electronically watermarked contents data in accordance with a predetermined electronic watermarking method capable of being handled by an output device controller owned by the user; and a supplying section which supplies the user with said electronically watermarked contents data.

The electronic watermarking information inserted by said electronic watermark inserting section may be a visible mark formed on said original contents.

The original contents data may be image data.

The output device may be a printer and said original contents data may be data capable of being printed.

Both said ID obtaining section and said supplying section may be connected with a network to which said output device controller owned by the user is also connected, said ID obtaining section obtaining the ID through said network while said supplying section supplying the user with said electronically watermarked contents data also through said network.

The ID obtaining section may be capable of reading information stored in a first storing medium, said ID obtaining section obtaining said ID by reading the ID from said first storing medium which is owned by said user and in which said ID has been previously stored, and wherein said supplying section is capable of writing information into a second storing medium. said supplying section supplying said user with said electronically watermarked contents data by writing the electronically watermarked contents data into said second storing medium which is owned by said user. In the contents data supplying device, said output device controller having first admittance section for conducting electronic admittance processing, wherein said contents data supplying device may further comprise: a second admittance section which conducts electronic admittance processing with said first admittance section and which produces a common key co-owned with said output device controller; and a coding section which codes said electronically watermarked contents data produced by said electronic watermark inserting section in a word, said supplying section supplying said user with the electronically watermarked contents data which are coded in a word by said coding section.

In the contents data supplying device, the storing section storing a fee for using said original contents data, said fee being related to the original contents data, wherein said contents data supplying device may further comprise a charging information managing section which obtains said fee related to said original contents data that the user hopes from said storing section and which notifies the user of the obtained fee.

According to still another aspect of the present invention, there is also provided an output device controller for use on a condition that the output device controller is connected to an output device and a contents data supplying device, said output device having an ID thereof, said contents data supplying device inserting electronic watermarking information including said ID into said original contents data to produce electronically watermarked contents data in accordance with a predetermined electronic watermarking method, wherein said output device controller may comprise: an ID obtaining section which obtains said ID from said output device, which notifies said contents data supplying device of the obtained ID, and which holds the obtained ID; a contents data obtaining section which obtains said electronically watermarked contents data from said contents data supplying device; an electronic watermark extracting section which extracts electronic watermarking information from said electronically watermarked contents data obtained by said contents data obtaining section; an ID judging section which compares a part of said electronic watermarking information extracted by said electronic watermark extracting section with said ID held by said ID obtaining section to judge whether or not both said part of said electronic watermarking information and said ID held by said ID obtaining section are identical with each other; a contents data deforming section which deforms said electronically watermarked contents data to produce deformed contents data, when said ID judging section has judged that both said part of said electronic watermarking information and said ID held by said ID obtaining section be identical with each other; and an output data producing section which produces output data capable of being handled by said output device from said deformed contents data.

The deformed contents data may be said original contents data, said contents data deforming section deforming said electronically watermarked contents data by removing said electronic watermarking information therefrom to reproduce said original contents data.

In the output device controller, said contents data supplying device having first admittance section for conducting electronic admittance processing and being capable of coding said electronically watermarked contents data in a word by a predetermined key, wherein said output device controller may further comprise: a second admittance section which conducts electronic admittance processing with said first admittance section and which produces a common key co-owned with said contents data supplying device as said predetermined key; and a decoding section which decodes said electronically watermarked contents data coded in a word by using said common key in said contents data supplying device and which outputs the decoded electronically watermarked contents data to said contents data obtaining section.

According to yet another aspect of the present invention, there is also provided an output device controller for use on a condition that the output device controller is connected to an output device and a contents data supplying device, said output device having an ID thereof, said contents data supplying device inserting first electronic watermarking information partially including said ID into said original contents data to produce first electronically watermarked contents data in accordance with a predetermined electronic watermarking method, wherein said output device controller may comprise: an ID obtaining section which obtains said ID from said output device, which notifies said contents data supplying device of the obtained ID, and which temporarily holds the obtained ID; a contents data obtaining section which obtains said first electronically watermarked contents data from said contents data supplying device; an electronic watermark extracting section which extracts first electronic watermarking information from said first electronically watermarked contents data obtained by said contents data obtaining section; an ID judging section which compares a part of said first electronic watermarking information extracted by said electronic watermark extracting section with said ID held by said ID obtaining section to judge whether or not both said part of said first electronic watermarking information and said ID held by said ID obtaining section are identical with each other; a contents data deforming section which deforms said first electronically watermarked contents data to produce deformed contents data, when said ID judging section has judged that both said part of said first electronic watermarking information and said ID held by said ID obtaining section be identical with each other; an electronic watermark inserting section at controller side which inserts second electronic watermarking information partially including said ID held by said ID obtaining section into said deformed contents data to produce second electronically watermarked contents data; and an output data producing section which produces output data capable of being handled by said output device from said second electronically watermarked contents data.

The second electronic watermarking information inserted by said electronic watermark inserting section at controller side may be an invisible mark formed on contents of said deformed contents data produced by said contents data deforming section.

The deformed contents data may be said original contents data, said contents data deforming section deforming said first electronically watermarked contents data by removing said first electronic watermarking information therefrom to reproduce said original contents data.

In the output device controller, said contents data supplying device having first admittance section for conducting electronic admittance processing and being capable of coding said electronically watermarked contents data in a word by a predetermined key, wherein said output device controller may further comprise: a second admittance section which conducts electronic admittance processing with said first admittance section and which produces a common key co-owned with said contents data supplying device as said predetermined key; and a decoding section which decodes said electronically watermarked contents data coded in a word by using said common key in said contents data supplying device and which outputs the decoded electronically watermarked contents data to said contents data obtaining section.

### BRIEF DESCRIPTION OF THE DRAWINGS

FIG. 1 is a block diagram for schematically showing a constitution of a contents data supplying system according to embodiments of the present invention;

FIG. 2 is a sequence chart for schematically showing operations of a contents data supplying system according to a first embodiment of the present invention;

FIG. 3 is a block diagram for schematically showing an example of an output device controller and a printer as an output device both of which can be applied to the contents data supplying system according to the first embodiment of the present invention;

FIG. 4 is a block diagram for schematically showing another example of an output device controller and a printer as an output device both of which can be applied to the contents data supplying system according to the first embodiment of the present invention;

FIG. 5 is a block diagram for schematically showing an example of a contents data supplying device which can be applied to the contents data supplying system according to the first embodiment of the present invention;

FIG. 6 is a block diagram for schematically showing another example of a contents data supplying device which can be applied to the contents data supplying system according to the first embodiment of the present invention;

FIG. 7 is a block diagram for schematically showing an example of an output device controller which can be applied to a contents data supplying system according to a second embodiment of the present invention;

FIG. 8 is a block diagram for schematically showing an example of a contents data supplying device which can be applied to the contents data supplying system according to the second embodiment of the present invention;

FIG. 9 is a sequence chart for schematically showing operations of the contents data supplying system according to the second embodiment of the present invention;

FIG. 10 is a block diagram for schematically showing an example of a contents data supplying device which can be applied to a contents data supplying system according to a third embodiment of the present invention;

FIG. 11 is a block diagram for schematically showing an example of an output device controller which can be applied to the contents data supplying system according to the third embodiment of the present invention; and

FIG. 12 is a sequence chart for schematically showing operations of the contents data supplying system according to the third embodiment of the present invention.

### DETAILED DESCRIPTION OF THE PREFERRED EMBODIMENTS

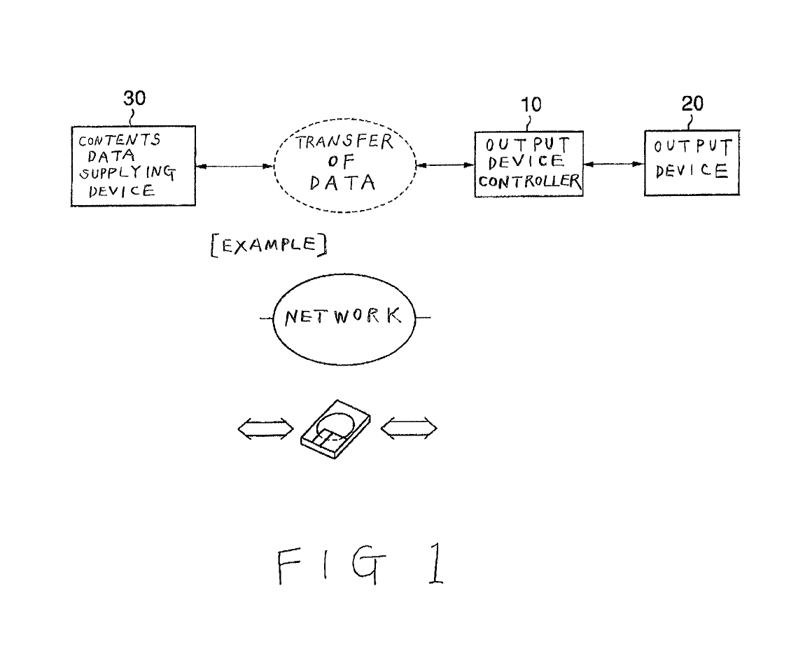

Referring to FIGS. 1 through 12, description will proceed to a method of supplying contents data and a contents data supplying system according to preferred embodiments of the present invention

[First Embodiment]

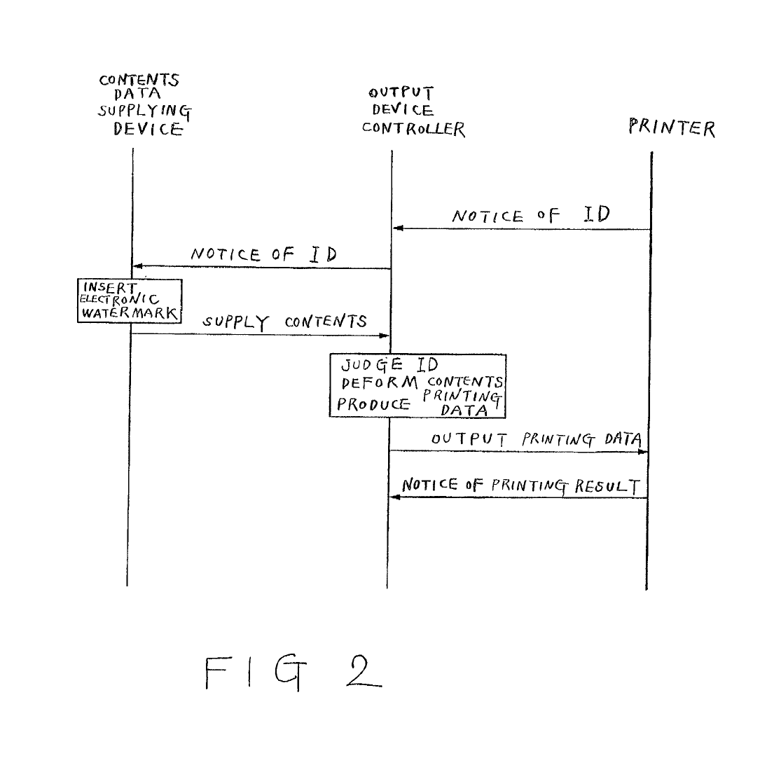

Now, description is made about a method of supplying contents data and a contents data supplying system according to a first embodiment of the present invention. FIG. 1 is a block diagram for schematically showing a constitution of the contents data supplying system while FIG. 2 is a sequence chart for schematically showing operations of the contents data supplying system.

As illustrated in FIG. 1, the contents data supplying system according to the first embodiment of the present invention comprises an output device controller 10, an output device 20, and a contents data supplying device 30. In the contents data supplying system, the output device 20 has an original ID and is connected with the output device controller 10. The output device controller 10 can conduct the transfer of data with the contents data supplying device 30.

Each of the output device controller 10, the output device 20, and the contents data supplying device 30 will later be described more in detail with various examples thereof At first, referring to FIG. 2, each of the output device controller 10, the output device 20, and the contents data supplying device 30 is schematically described together with schematic operations of the contents data supplying system. Although a printer will be hereunder described as an example of the output device 20 with the reference numerals 20 used therefor, the present invention can also be applied to various output devices other than the printer 20.

As illustrated in FIG. 2, the output device controller 10 obtains an ID of the printer 20 from the printer 20. The output device controller 10 then notifies the contents data supplying device 30 of the ID of the printer 20. The contents data supplying device 30 inserts an electronic watermarking information including the ID notified by the output device controller 10 into contents data hoped by a user who owns the printer 20 and the output device controller 10 to be buried therein. The contents data supplying device 30 then supplies the contents data having the electronic watermarking information buried therein to the output device controller 10 as electronically watermarked contents data. The contents data hoped by a user will hereunder be called “original contents data” so as to be distinguished from deformed contents data, and the like. The output device controller 10 compares the ID as a part of the electronic watermarking information inserted in the electronically watermarked contents data with the abovementioned ID obtained from the printer 20 to judge whether or not both are identical with each other. When the both IT)s are identical with each other, the output device controller 10 deforms the electronically watermarked contents data and then produces printing data capable of being printed by the printer 20. The printing data are outputted from the output device controller 10 to the printer 20, so that the printing data are printed by the printer 20. In this embodiment, particularly, the printer 20 investigates by itself whether or not the printing data have been completely printed. The printer 20 then notifies the output device controller 10 of the result of investigation as printing result information.

By using the method thus mentioned, from a viewpoint of contents data supplying device, distribution of contents data can be carried out on a condition that a printer capable of printing the contents data is specified. On the other hand, at an user's side, even if the user intends an unfair use of the contents data, such as transfer of a copy of the contents data to the third party, the contents data can be completely printed only by a printer having the ID identical with the part of the electronic watermarking information buried therein. In other words, the contents data cannot be completely printed by a printer owned by the third party. As a result, the unfair use of the contents data can be prevented effectively.

Herein, a transmission path for connecting the output device 20 with the output device controller 10 can be composed of a serial interface, such as IEEE 1394 high speed serial bus (IEEE Std 1394-1995, Standard for a High Performance Serial Bus), USB (Universal Serial Bus), and the like. Alternatively, the transmission path can also be composed of a parallel interface, or the like that has been conventionally used for connecting a personal computer (hereunder called “PC”) with a printer.

Further, as illustrated in FIG. 1, a network represented by, for example, an Internet, storing medium, broadcasting medium, or the like can be used as data transfer means between the output device controller 10 and the contents data supplying device 30. In a case that a network is used as the data transfer means, a physical level constituting the network is not restricted at all. Namely, any communication medium, such as telephone line (analogue subscriber s line). ISDN, xDSL, cable modem, optical fiber, and the like can be used as the data transfer means. Further, also the storing medium is not restricted particularly. Namely, any storing medium, such as FD, MO, CD-ROM, DVD, magnetic tape, and the like can be used. Moreover, various broadcasting medium, such as CS digital broadcasting, BS digital broadcasting, ground wave digital broadcasting, and the like can be used, dependent on a constitution of the contents data supplying system.

When an Internet is used as the data transfer means, the contents data supplying device 30 can be composed of, for example, an WWW server, and the like in cooperation with a data base, and the like. In addition, the output device controller 10 can be composed as a plug in of the WWW browser operable on a PC at an user s side. In this case, the contents data supplying device 30 can notify the WWW browser at an user s side of various information and a request for data input, such as an ID request, and the like in a manner of Web page, or the like.

On the other hand, when the storing medium are used as the data transfer means, the contents data supplying device 30 can be composed of, for example, a kiosk terminal provided in a convenience store, or the like. In addition, the output device controller 10 can be composed as a program operable on a PC owned by a user. In this case, a supply of contents data is, for example, schematically described as follows. At first. the user carries out the program for realizing the output device controller 10 on a PC connected to the printer 20 so that ID of the printer 20 is stored in the storing medium. On the condition that the ID of the printer 20 is stored in the storing medium, the user comes to a place in which the contents data supplying device 30 is provided. A panel for notifying a user of an indication, and the like is provided in the contents data supplying device 30. A request for insertion of the storing medium having the ID stored therein, and the like are displayed in the panel. In response to the request, the user inserts the storing medium in the contents data supplying device 30 and designates the contents data hoped by the user. As a result, the contents data supplying device 30 inserts the electronic watermark into the contents data, as mentioned above, and writes the electronically watermarked contents data into the storing medium. The user carries out the program for realizing the output device controller 10 on the PC again to process the electronically watermarked contents data stored in the storing medium to be printed by the printer 20.

Further, when the contents data supplying device 30 is composed of the kiosk terminal provided in the convenience store, or the like, a device for storing original contents data can be provided in a center while the other portions for conducting insertion of the electronic watermark may be provided in the kiosk terminal. Moreover, in this case, an existing network may be used for connecting the center with the kiosk terminal.

Besides, it is desirable that not only data transferred between the output device controller 10 and the printer 20 but also data transferred between the output device controller 10 and the contents data supplying device 30 are adequately coded in a word, respectively. For example, in relation to the latter, when the data transfer means are particularly the Internet, it is possible SSL technique, XHTML technique, and the like are applied to the data transfer means. Furthermore, when each of processing internally conducted in each of the output device controller 10, the printer 20, and the contents data supplying device 30 is achieved by a combination of a processor and a program, it is desirable that the contents of the processing can be prevented from being known or altered by an user. For this purpose, it is desirable that the program for the processing is rendered to be difficult to read by the use of tamper-registering method.

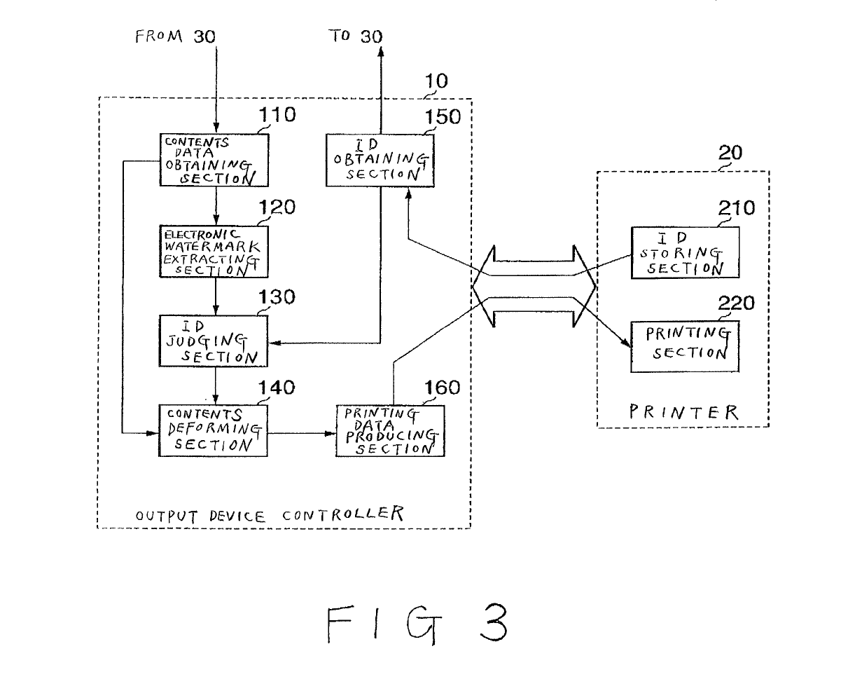

Now, referring to FIGS. 3 through 6, more detailed description will be made as regards the output device controller 10, the printer 20, and the contents data supplying device 30 each of which can be applied to the contents data supplying system mentioned above.

FIG. 3 is a block diagram for schematically showing each constitution of the output device controller 10 and the printer 20 in this embodiment.

As illustrated in FIG. 3, the output device controller 10 comprises a contents data obtaining section 110, an electronic watermark extracting section 120, an ID judging section 130, a contents deforming section 140, an ID obtaining section 150, and a printing data producing section 160. On the other hand, the printer 20 comprises an ID storing section 210 for storing ID of the printer 20 itself and a printing section 220 for printing the printing data. In the constitution of the printer 20, the ID storing section 210 is not restricted to something like hardware. Namely, the ID storing section 210 may be composed of, for example, a semiconductor memory, such as ROM, RAM, and the like, magnetic storing medium, such as magneto-optical disk, and the like, and further an IC card, a non-volatile memory card, and the like including those ROM, RAM, and the magneto-optical disk.

In the output device controller 10 illustrated in FIG. 3, the ID obtaining section 150 obtains ID from the ID storing section 210 of the printer 20. The ID obtaining section 150 then holds the obtained ID temporarily and notifies the contents data supplying device 30 of the obtained ID. Consequently, the contents data supplying device 30 can insert electronic watermarking information partially including the notified ID into the original contents data in accordance with a predetermined electronic watermarking method. The contents data supplying device 30 can therefore supply the electronically watermarked contents data to the output device controller 10. The contents data obtaining section 110 obtains the electronically watermarked contents data from the contents data supplying device 30. The electronic watermark extracting section 120 extracts the electronic watermarking information buried in the electronically watermarked contents data therefrom. The ID judging section 130 compares the ID temporarily held by the ID obtaining section 150 with another ID constituting a part of the electronic watermarking information (the ID buried into the electronic watermarking information at the side of the contents data supplying device 30) to judge whether or not both are identical with each other. The contents data deforming section 140 carries out deforming processing of the electronically watermarked contents data to output deformed contents data. Herein, in the deforming processing of the electronically watermarked contents data of this embodiment, the deformed contents data are the original contents data. The contents data deforming section 140 then deforms the electronically watermarked contents data by removing the electronic watermarking information therefrom to reproduce the original contents data, when both of the IDs are identical with each other in the ID judging section 130. The printing data producing section 160 produces printing data capable of being handled by the printer 20 from the deformed contents data (Namely, reproduced original contents data). The printing data producing section 160 then outputs the printing data to the printing section 220. Thus, original contents depicted by the original contents data are printed in the printer 20.

Herein, description is made about the predetermined electronic watermarking method used in this embodiment. It is enough for the electronic watermarking method used in this embodiment to have two features in one of which the electronic watermarking information can be extracted by the electronic watermark extracting section 120 and in another one of which deformation, such as removal of the electronic watermark, or the like can be carried out by the contents data deforming section 140. The electronic watermarking method used in this embodiment is not restricted to a specific electronic watermarking method. For example, a method disclosed in Nakasato and Matsui: “Proposal of signature watermarking method in which copy right is shown positively” Journals of The Insutitute of Image Electronics Engineers of Japan, Volume 27. No.5. (1998) may be used as the electronic watermarking method in this embodiment. When the method disclosed in Nakasato and Matsui is used, it is desirable that two method, namely, the signature method by Peano scanning and the electronic watermarking by distributing and concealing signatured information are used simultaneously. In the signature method by Peano scanning, pseudo random number sequences used for signature are prepared with respect to original image. Further, exclusive OR is calculated between original picture elements and the pseudo random number sequences in an order of Peano scanning. Moreover, another method can be used as the other electronic watermarking methods. In the another method, a reverse frequency conversion is carried out after an watermarking information is added to frequency field by performing frequency conversion, such as fast fourier transform (FFT), discrete cosine transform (DCT), wavelet transform (WT), and the like with respect to original contents data. As an example, in the above electronic watermarking method by using the fast fourier transform, after original contents data are distributed with PN sequence being added thereto, the original contents data are subjected to the Fast Fourier Transform per each block. Further, blocks in which the watermarking information are buried are subjected to a reverse fourier transform. Thereafter, the electronic watermarking information is buried into the blocks by adding the same PN sequence to the blocks again.

Further, described herein is a method of extracting the electronic watermarking information buried in the electronically watermarked contents data in the electronic watermark extracting section 120. When the data transfer means illustrated in FIG. 1 are an Internet, or the like, for example, it is desirable that an user obtains information for the method of extracting the electronic watermarking information and that the user extracts the electronic watermarking information based on the obtained information.

Moreover, in this embodiment, the contents data deforming section 140 removes the electronic watermarking information from the electronically watermarked contents data, as deforming processing of the electronically watermarked contents data, to reproduce the original contents data. As regards this, more concretely, the electronic watermarking information inserted in the contents data supplying device 30 may be a visible mark, in other words, may be electronic watermarking information buried by an electronic watermarking method of visible type. The contents data deforming section 140 desirably deletes the visible mark.

Furthermore, in the processing that the printing data producing section 160 produces printing data capable of being handled by the printer 20 from the deformed contents data, for example, error distribution method, and the like can be used. In the error distribution method, image data are binarized and the binarized data are developed in a band memory. On the other hand, another method can also be used. In the another method, image data are developed in a band memory as multivalued data. The developed image data are binarized per each raster line.

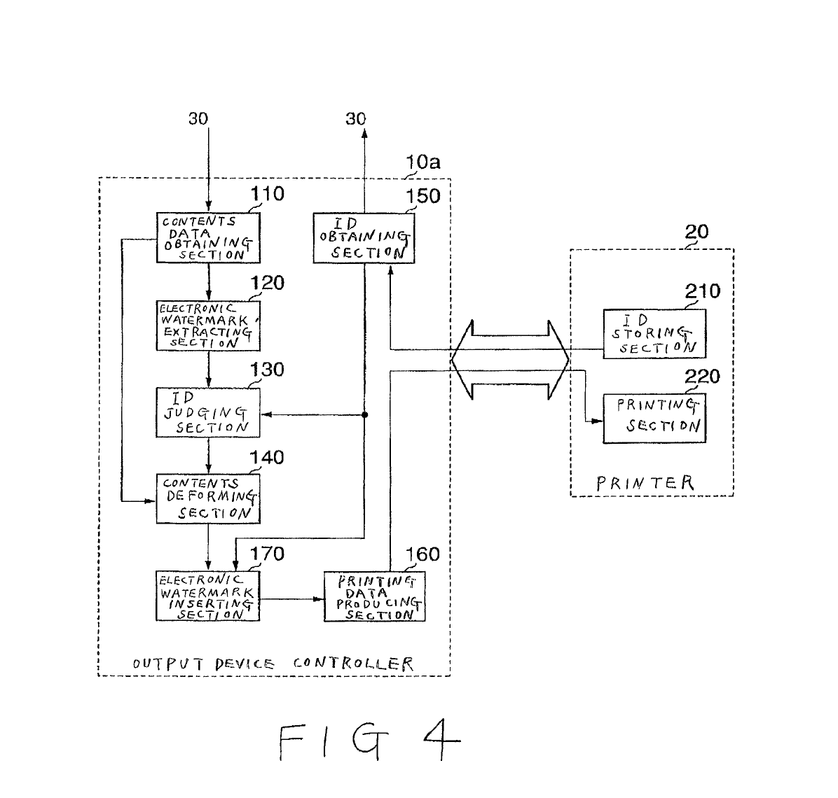

Next, referring to FIG. 4, description proceeds to another example of an output device controller 10a in this embodiment. FIG. 4 is a block diagram for schematically showing the another example of the output device controller 10a and the printer 20 both of which can be applied to the contents data supplying system according to this embodiment of the present invention.

As illustrated in FIG. 4, the output device controller 10a comprises a contents data obtaining section 110, an electronic watermark extracting section 120, an ID judging section 130, a contents data deforming section 140, an ID obtaining section 150, a printing data producing section 160, and an electronic watermark inserting section 170. In the structure, the contents data obtaining section 110, the electronic watermark extracting section 120, the ID judging section 130, the contents data deforming section 140, and the ID obtaining section 150 are operable similarly to those of the output device controller 10 illustrated in FIG. 3. Further, as will be understood from FIG. 4, the printing data producing section 160 is operable similarly to that of the output device controller 10 illustrated in FIG. 3 except that the object of operation therein is not an output of the contents data deforming section 140 but an output of the electronic watermark inserting section 170. Accordingly, similar portions are designated by like reference numerals.

The illustrated output device controller 10a is different from the above-mentioned output device controller 10 in a point that the output device controller 10a further comprises the electronic watermark inserting section 170. The electronic watermark inserting section 170 is for use in burying, for example, such electronic watermarking information as partially including ID held by the ID obtaining section 150 into the deformed contents data outputted by the contents data deforming section 140. In detail, the electronic watermark inserting section 170 is for use in inserting discrimination information for a printing person or a printing controller system, such as discrimination information for an user who conducts printing and for the output device controller, ID of the printer 20, and the like, and/or time information, such as day, month, year and the time when the printing is conducted, and the like into the deformed contents data as electronic watermarks.

Herein, it is preferable that the electronic watermarking information buried by the electronic watermark inserting section 170 are an invisible mark. On the other hand, in this case, it is preferable that another electronic watermarking information buried by the contents data supplying device 30 are a visible mark. Further, yet another method of electronically watermarking disclosed in unexamined Japanese Patent Publication Hei 11-119651 may be used in this embodiment. In the method disclosed therein, deletion of a visible mark and burying of an invisible mark are carried out parallelly, when the visible mark is deleted and the invisible mark is buried.

With the structure of the output device controller 10a, even if an unfair use of the contents data is caused to occur, it will be readily possible to identify an user related to the unfair use of the contents data.

Herein, operations of the output device controller 10a are described again. At first, in the output device controller 10a illustrated in FIG. 4, the ID obtaining section 150 obtains ID from the ID storing section 210 of the printer 20. The ID obtaining section 150 then holds the obtained ID temporarily and notifies the contents data supplying device 30 of the obtained ID. Consequently, the contents data supplying device 30 can insert electronic watermarking information partially including the notified ID into the original contents data in accordance with a predetermined electronic watermarking method. The contents data supplying device 30 can therefore supply the electronically watermarked contents data to the output device controller 10a. The contents data obtaining section 110 obtains the electronically watermarked contents data from the contents data supplying device 30. The electronic watermark extracting section 120 extracts the electronic watermarking information buried in the electronically watermarked contents data therefrom. The ID judging section 130 compares the ID temporarily held by the ID obtaining section 150 with another ID constituting a part of the electronic watermarking information (the ID buried into the electronic watermarking information at the side of the contents data supplying device 30) to judge whether or not both are identical with each other. The contents data deforming section 140 carries out deforming processing of the electronically watermarked contents data to output deformed contents data. Herein, in the deforming processing of the electronically watermarked contents data of this embodiment, the deformed contents data are the original contents data. The contents data deforming section 140 then deforms the electronically watermarked contents data by removing the electronic watermarking information therefrom to reproduce the original contents data, when both of the IDs are identical with each other in the ID judging section 130 The electronic watermark inserting section 170 carries out insertion processing of the electronic watermark into the deformed contents data (namely, the reproduced original contents data in this embodiment). The printing data producing section 160 produces printing data capable of being handled by the printer 20 from the contents data into which the electronic watermark has been inserted by the electronic watermark inserting section 170 The printing data producing section 160 then outputs the printing data to the printing section 220. Herein, when the electronic watermark inserted by the electronic watermark inserting section 170 is an invisible mark, the printing data bring a printing result similar to the case in which original contents are printed. Upon receiving such printing data, the printer 20 prints original contents depicted by the original contents data.

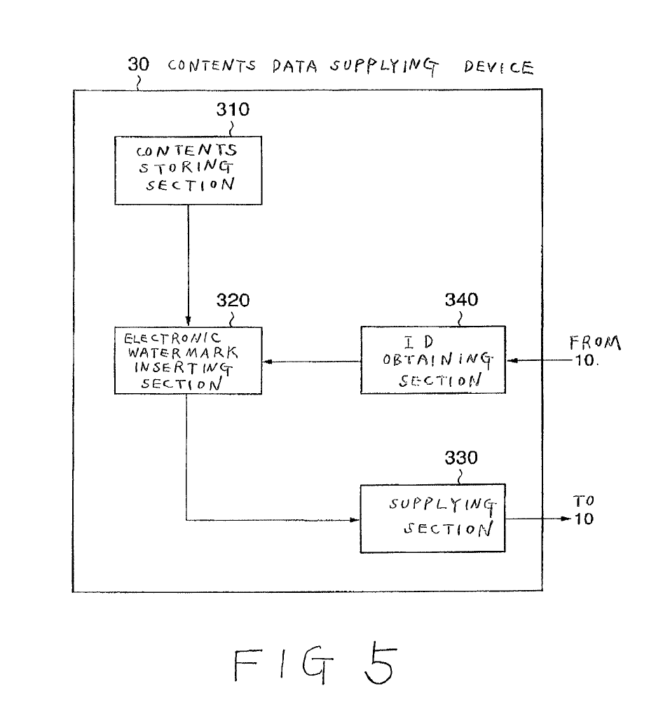

Next, referring to FIG. 5, description will proceed to a concrete structure of the contents data supplying device 30.

As illustrated in FIG. 5, the contents data supplying device 30 comprises a contents storing section 310, an electronic watermark inserting section 320, a supplying section 330, and an ID obtaining section 340. The contents storing section 310 is storing original contents data previously. The ID obtaining section 340 obtains ID of the printer 20 from the output device controller 10 through the data transfer means, such as an Internet, or the like. Concretely, the ID obtaining section 340 urges an input of ID, for example, by sending a request for transmission of ID to the output device controller 10 at the user's side. The ID obtaining section 340 obtains the ID thereby transmitted. In this time, before or immediately after the request for transmission of ID, the ID obtaining section 340 receives designation of the original contents data desired by an user from the user's side. Upon receiving the ID from the ID obtaining section 340, the electronic watermark inserting section 320 obtains the original contents data desired by the user from the contents storing section 310. The electronic watermark inserting section 320 buries the obtained ID into the original contents data as electronic watermarking information in accordance with a predetermined electronic watermarking method. The predetermined electronic watermarking method used herein is similar to those mentioned above. It is enough that the predetermined electronic watermarking method used herein is the same method as that used in the electronic watermark extracting section 120. Further, the electronic watermark inserting section 320 outputs the original contents data having such electronic watermarking information buried therein to the supplying section 330 as electronically watermarked contents data. The supplying section 330 supplies the electronically watermarked contents data to the output device controller 10 through the data transfer means, such as an Internet, or the like.

When the data transfer means are a network, such as an Internet, or the like, both the ID obtaining section 340 and the supplying section 330 in the contents data supplying device 30 are connected to the network. The ID obtaining section 340 obtains ID through the network while the supplying section 330 supplies the electronically watermarked contents data to the output device controller 10 through the network. On the other hand, when the data transfer means are storing medium, the ID obtaining section 340 reads ID stored in the storing medium while the supplying section 330 writes the electronically watermarked contents data in the storing medium. Herein, the storing medium for storing ID and the storing medium in which the electronically watermarked contents data are written may be either the same media and the media different from each other.

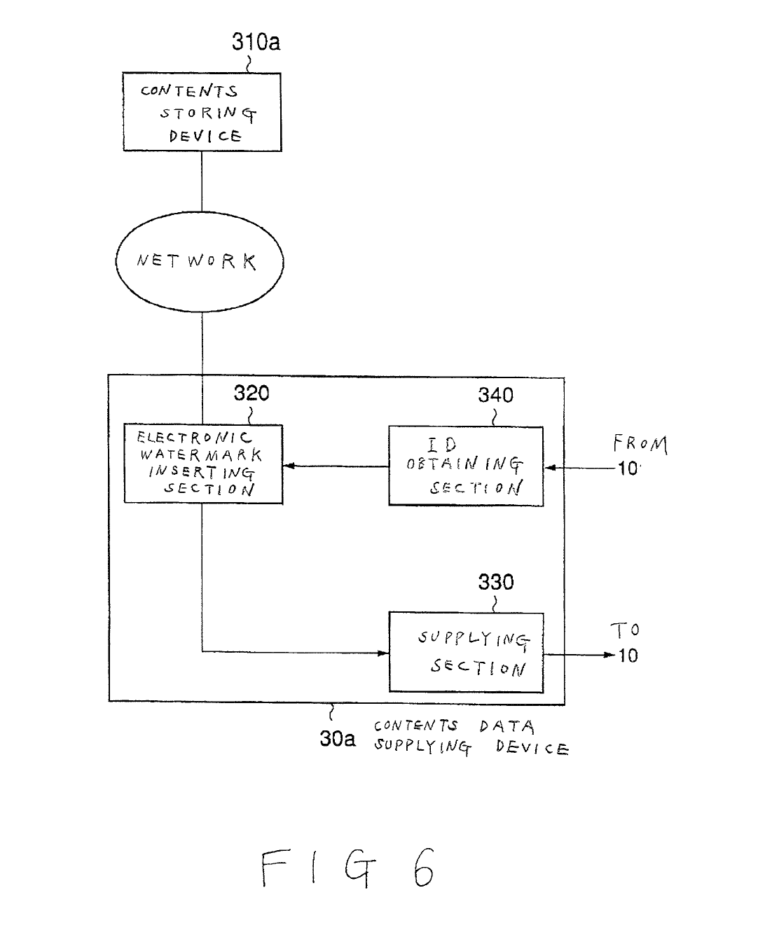

As mentioned before, the contents data supplying device may be composed of the kiosk terminal. When the contents data supplying device composed of the kiosk terminal is provided, for example, in the convenience store, or the like, and is connected to the center through a network, the contents data supplying device can be alternatively varied as illustrated in FIG. 6.

Namely, the contents data supplying device 30a illustrated in FIG. 6 comprises an electronic watermark inserting section 320, a supplying section 330, and an ID obtaining section 340, similarly to the contents data supplying device 30 illustrated in FIG. 5. On the other hand, a contents storing device 310a is provided at the side of the center connected to the contents data supplying device 30a through a network. The contents storing device 310a stores original contents data and is composed of, for example, a data base, similarly to the contents storing section 310 illustrated in FIG. 5.

[Second Embodiment]

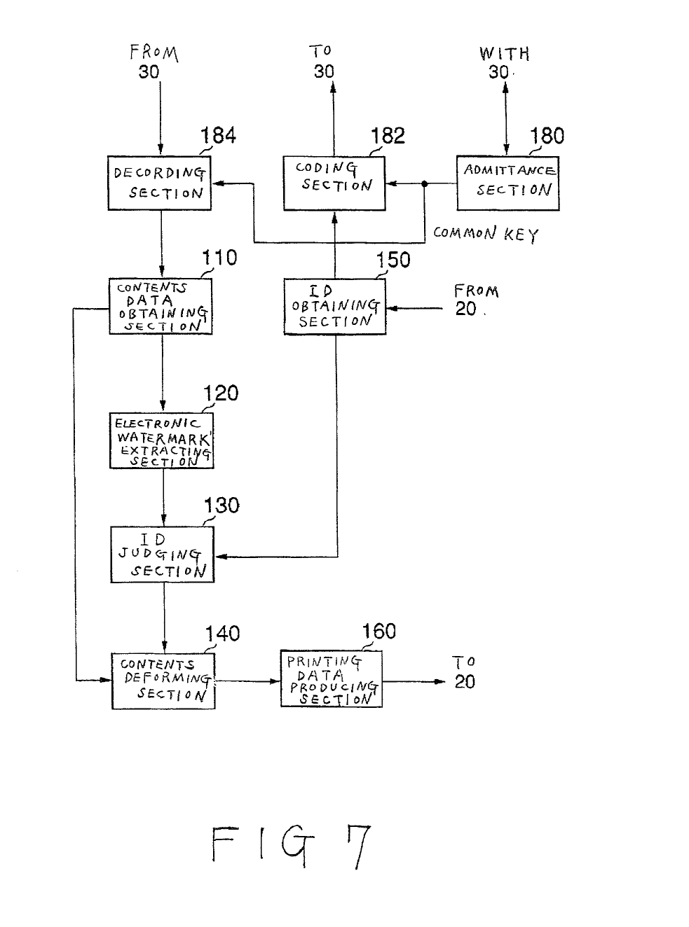

Referring to FIGS. 7 through 9, description will proceed to a method of supplying contents data and a contents data supplying system according to a second embodiment of the present invention.

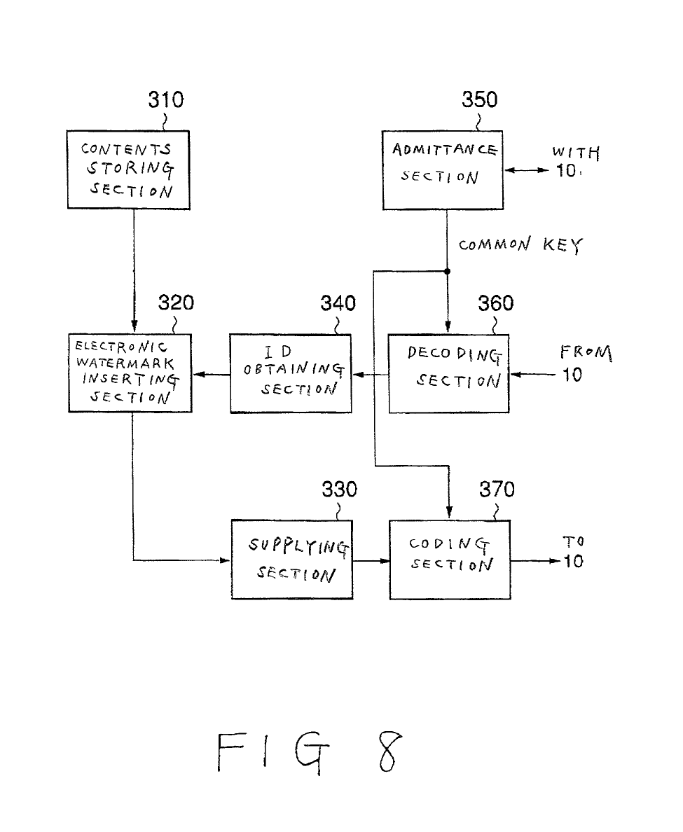

In addition to the constitution of the first embodiment (shown in FIG. 5), the contents data supplying device 30 in this embodiment further comprises an admittance section 350, a decoding section 360, and a coding section 370, as illustrated in FIG. 8. The output device controller 10 in this embodiment also further comprises an admittance section 180, a coding section 182, and a decoding section 184, as illustrated in FIG. 7, in addition to the constitution of the first embodiment (shown in FIG. 3).

The admittance section 350 of the contents data supplying device 30 and the admittance section 180 of the output device controller 10 carry out an electronic admittance in accordance with a predetermined communication protocol, respectively, through the data transfer means, such as the Internet, or the like It is preferable that the electronic admittance is carried out by an electronic signature method and a key distribution method. Various methods that have already been created can be used as the electronic signature method and the key distribution method. For example, elliptic DSA (Digital Signature Algorithm) signature and elliptic DH (Diffie-Hellman) key distribution can be used. Hereunder, the elliptic DSA signature (Hereunder, called EC-DSA) is described. EC-DSA is defined in ANSI X9.62, and the like The contents of EC-DSA are composed of three stages, such as key production, signature production, and signature collation. Hereunder, description is made about steps of each stage of the three stages. However, device A and device B are used instead of the contents data supplying device and the output device controller in order to omit the overlapping of the description. In other words, the admittance section 350 at the side of the contents data supplying device 30 becomes operable as the device A, when the electronic admittance is carried out by the lead of the admittance section 350. On the contrary, the admittance section 350 becomes operable as the device B, when the admittance section 350 is operated as a receiver. Similar relations are applied to the output device controller.

First, steps of key production are described.

(1) EC-DSA Key Production

In the device A:

Step 1: An elliptic curve E to be formed on ZP is selected. Numbers of points on E(ZP) must be divisible by a large prime number n.

Step 2: The point P of an order n PεE (ZP) is selected.

Step 3: Among interval [1, n−1], a peculiar and unpredictable integral number d is selected statically.

Step 4: Q=dP is calculated.

Step 5: Public key of A is (E,P,n, Q) while secret key of A is d.

Next, steps of signature production are described.

(2) EC-DSA Signature Production

In the device A, a message m is coded in a word as follows.

Step 1: Among interval [1, n−1], a peculiar and unpredictable integral number k is selected statically.

Step 2: kP=(x1, y1) and r=x1 mod n are calculated.

Herein, x1 is deemed to be an integral number, for example, by conversion from binary expression. If r=0, then returns to the step 1 (Because of the reason for security. If r=0, a cipher equation S=k−1 {h(m)+dr} mod n does not include secret key d).

Step 3: k−1 mod n is calculated.

Step 4: S=k−1 {h(m)+dr} mod n is calculated. Herein, h is secure hachu algorithm (SHA−1).

Step 5: If s=0, then returns to the step 1 (Because of the reason for security. If s=0, s−1 mod n does not exist, s−1 is required for signature collation in step 2 thereof).

Step 6: Signature of the message in is a combination of integral numbers [r, s].

Next, steps of signature collation are described.

(3) EC-DSA Signature Collation

In order to collate the signature (r, s) of the device A among n, the device B carries out the following steps.

Step 1: A true copy of the public key of A (E,P,n, Q) is obtained.

Step 2: It is collated that r and s are integral numbers among interval [1, n−1].

Step 3: W=s−1 mod n and h(m) are calculated.

Step 4: u1=h(m)W mod n and h(m) are calculated.

Step 5: u1P+u2Q=(x0, y0) and v=x0 mod n are calculated.

Step 6: If v=r, signature is required.

Next, description is made about the elliptic DH (Diffie-Hellman) key distribution (Hereunder, called EC-DH). EC-DH is defined in ANSI X9.63, and the like. The contents of EC-DH are composed of two stages, such as key production and key exchange, and key co-owning. At first, steps of key production and key exchange are described.

(1) EC-DH Key Production and Key Exchange

In the device A:

Step 1: Among interval [2, n−2], a peculiar and unpredictable integral number x is selected statically.

Step 2: a=xP is calculated.

Step 3: the device A sends a to the device B.

In the device B:

Step 1: Among interval [2, n−2], a peculiar and unpredictable integral number y is selected statically.

Step 2: b=yP is calculated.

Step 3: the device B sends b to the device A.

Next, steps of key co-owning are described.

(2) EC-DH Key Co-Owning

Step 1: A common key is produced by KA=xb=xyP in the device A.

Step 2: A common key is produced by KB=xa=xyP in the device B.

Step 3: The device A and the device B co-own the key, because KA=KB.

The electronic admittance is carried out by the steps mentioned above.

The common key is co-owned thus mentioned. As a result, coding and decoding operations are carried out in the contents data supplying device and in the output device controller, respectively, by the use of the common key. Further, supply of contents data are conducted using the coding and the decoding operations. Any methods of coding and decoding that have already been proposed can be applied to the coding and the decoding operations.

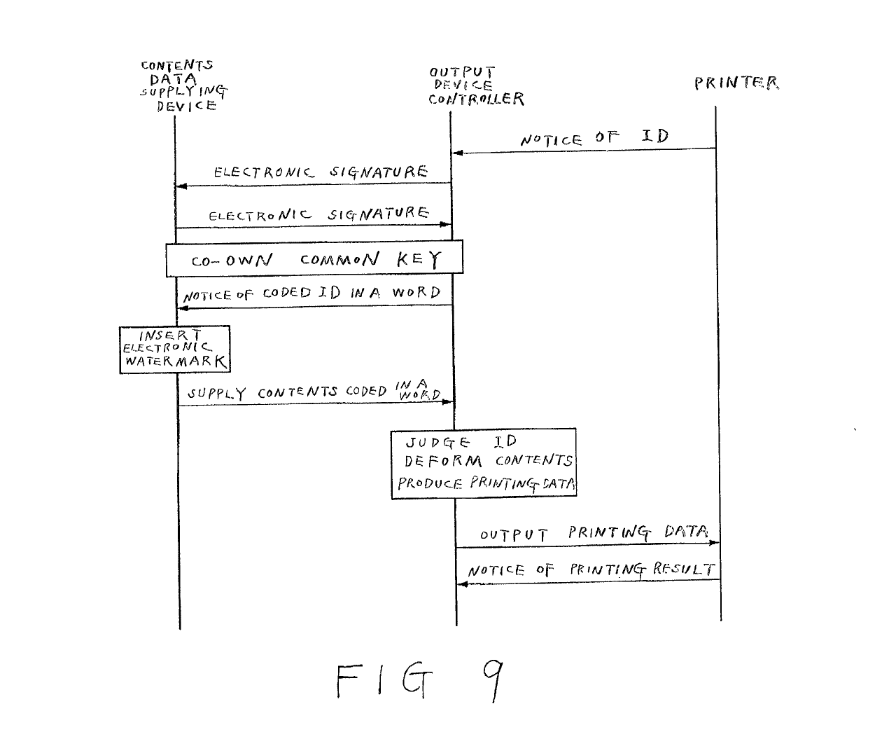

Referring to FIG. 9 with reference to FIGS. 7 and 8 continued, description is made as regards operation and function of each section. At first, the printer 20 notifies the output device controller 10 of the ID of the printer 20 stored in the ID storing section 210 (ID notification). The output device controller 10 makes an electronic signature by using the admittance section 180. The output device controller 10 then transmits the electronic signature to the contents data supplying device 30. On the other hand, the contents data supplying device 30 makes another electronic signature by using the admittance section 350. The contents data supplying device 30 then transmits the electronic signature to the output device controller 10 (Electronic signature).

As the result of the electronic admittance processing, the output device controller 10 and the contents data supplying device 30 come to co-own the common key thus mentioned above.

Thereafter, the admittance section 180 notifies the coding section 182 and the decoding section 184 of the common key obtained as the result of the electronic admittance processing, as illustrated in FIG. 7. On the other hand, at the side of the contents data supplying device 30, the admittance section 350 notifies the decoding section 360 and the coding section 370 of the common key obtained as the result of the electronic admittance processing, as illustrated in FIG. 8.

Further, upon receiving ID from the ID obtaining section 150, the coding section 182 at the side of the output device controller 10 conducts a coding processing of the ID by the use of the common key. The coding section 182 then transmits the coded ID in a word to the side of the contents data supplying device 30 (Coded TD notification).

Upon receiving the coded ID in a word, the decoding section 360 at the side of the contents data supplying device 30 conducts a decoding processing of the coded ID in a word by the use of the common key. The decoding section 360 then notifies the ID obtaining section 340 of the decoded ID. Thereafter, processing are carried out similarly to those of the above-mentioned first embodiment, until the electronically watermarked contents data are outputted from the supplying section 330.

Upon receiving the electronically watermarked contents data from the supplying section 330, the coding section 370 at the side of the contents data supplying device 30 conducts a coding processing of the electronically watermarked contents data by the use of the common key. The coding section 370 then supplies the coded electronically watermarked contents data to the side of the output device controller 10 (Coded contents supply).

Upon receiving the coded electronically watermarked contents data from the side of the contents data supplying device 30, the decoding section 184 at the side of the output device controller 10 conducts a decoding processing of the coded electronically watermarked contents data by the use of the common key received from the admittance section 180. The decoding section 184 then outputs the decoded electronically watermarked contents data to the contents obtaining section 110. Thereafter, processing are carried out similarly to those of the above-mentioned first embodiment, until the printing data are outputted from the printing data producing section 160 to be printed by the printer 20. Further, also in this embodiment, the printer 20 investigates by itself whether or not the printing data have been completely printed, similarly to the first embodiment. The printer 20 then notifies the output device controller 10 of the result of investigation as printing result information.

Besides, also in this embodiment, it is desirable that the contents of the processing internally conducted in each of the output device controller 10, the printer 20, and the contents data supplying device 30 can be prevented from being known or altered by an user. For this purpose, it is desirable that the program for the processing is rendered to be difficult to read by the use of tamper-registering method.

In the second embodiment mentioned above, as illustrated in FIGS. 7 and 8, the contents data supplying device 30 and the output device controller 10 comprise the coding sections (370, 182) and the decoding sections (360, 184), respectively. However, the contents data supplying device 30 may not have the coding section 370 but have the decoding section 360 while the output device controller 10 may not have the decoding section 184 but have the coding section 182. Alternatively, the contents data supplying device 30 may not have the decoding section 360 but have the coding section 370 while the output device controller 10 may not have the coding section 182 but have the decoding section 184. Further, the printer 20 may comprise an admittance section and a decoding section.

Moreover, in the above embodiment, an example of variation to have an admittance section, a coding section and a decoding section is described based on the structures of the output device controller 10 and the contents data supplying device 30 illustrated in FIGS. 3 and 5. However, the output device controller 10 may have those sections based on the structure illustrated in FIG. 4. On the other hand, the contents data supplying device 30 may have those sections based on the structure illustrated in FIG. 6.

[Third Embodiment]

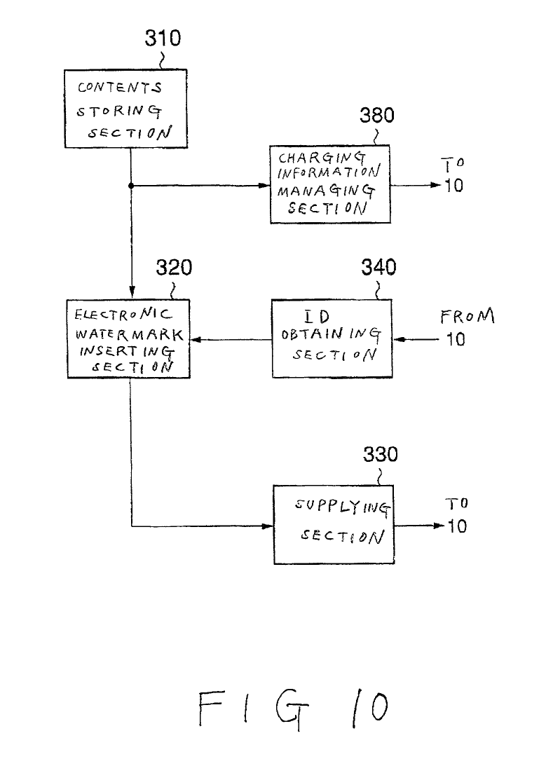

Referring to FIGS. 10 through 12, description will proceed to a method of supplying contents data and a contents data supplying system according to a third embodiment of the present invention.

In addition to the constitution of the first embodiment (shown in FIG. 5), as illustrated in FIG. 10, the contents data supplying device 30 in this embodiment further comprises a charging information managing section 380. The charging information managing section 380 has a data base in which charging information, such as an use fee related to original contents data, and the like are stored. The charging information managing section 380 sends the charging information responsive to the original contents data read from the contents storing section 310 to the side of the output device controller 10. Herein, the data base storing the charging information may be provided separately from the charging information managing section 380. Alternatively. the data base storing the charging information may be incorporated in the contents storing section 310. In the structure being illustrated, the charging information managing section 380 is incorporated in the contents data supplying device 30. However, the charging information managing section 380 may be provided separately from the contents data supplying device 30. In such a case, the data base storing the charging information may be incorporated in the independent charging information managing section. Further, the data base storing the charging information may be provided separately from the independent charging information managing section or incorporated in the contents storing section 310.

Besides, the other sections illustrated in FIG. 10, namely, a contents storing section 310, an electronic watermark inserting section 320, a supplying section 330, and an ID obtaining section 340 are operable similarly to those of the above-mentioned first embodiment.

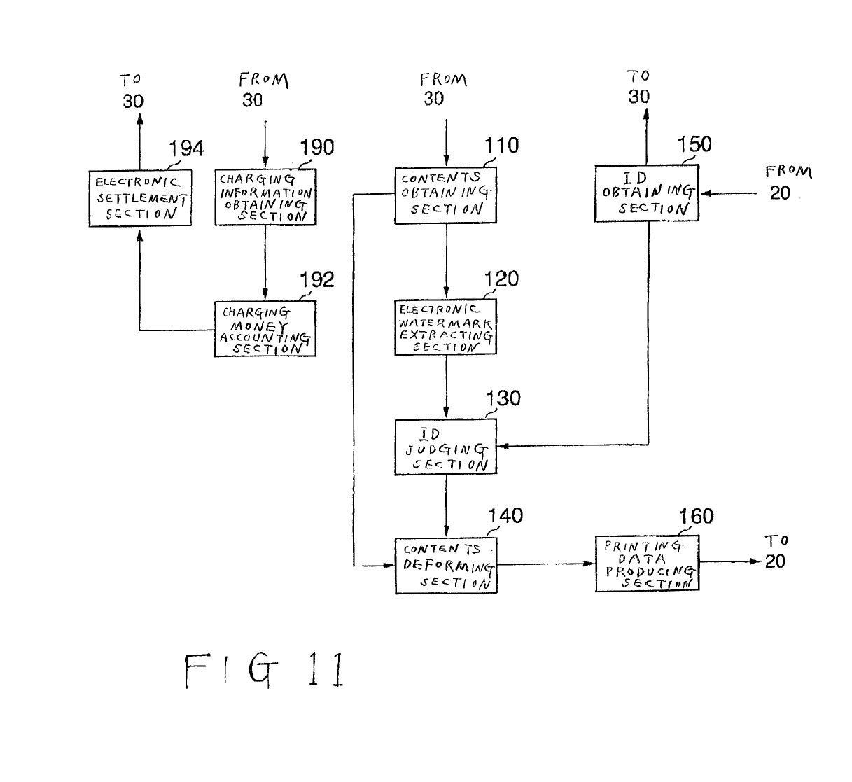

On the other hand, in addition to the constitution of the first embodiment (shown in FIG. 3), as illustrated in FIG. 11, the output device controller 10 in this embodiment further comprises a charging information obtaining section 190, a charging money accounting section 192, and an electronic settlement section 194. The charging information obtaining section 190 obtains the charging information from the charging information managing section 380. The charging money accounting section 192 collects the charging information and calculates charging money per each predetermined period, based on the charging information obtained by the charging information obtaining section 190. The electronic settlement section 194 is for use in an electronic settlement of the charging money calculated by the charging money accounting section 192. The electronic settlement section 194 notifies the contents data supplying device 30 (concretely, the charging information managing section 380) of the settlement information. Any existing methods of electronic settlement, such as a credit card, electronic money, and the like can be used as the electronic settlement in the electronic settlement section 194. Besides, in FIG. 11, the charging information obtaining section 190, the charging money accounting section 192, and the electronic settlement section 194 are incorporated in the output device controller 10. However, these sections may be provided separately from the output device controller 10.

Besides, the other sections illustrated in FIG. 11, namely, a contents obtaining section 110, an electronic watermark extracting section 120, an ID judging section 130, a contents deforming section 140, an ID obtaining section 150, and a printing data producing section 160 are operable similarly to those of the above-mentioned first embodiment.

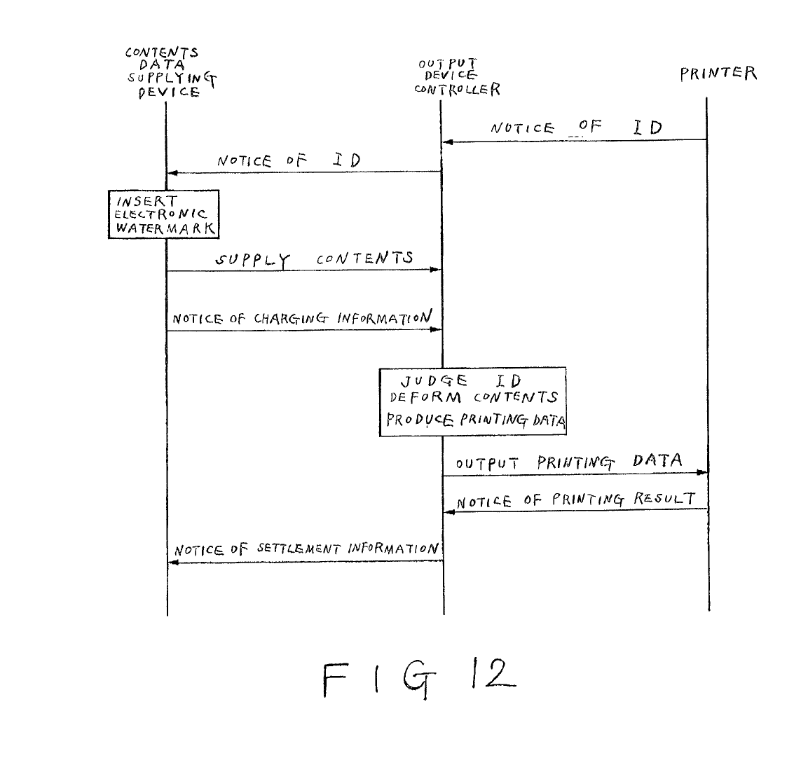

Referring to FIG. 12 with reference to FIGS. 10 and 11 continued, description is made as regards operation and function of each section. At first, the printer 20 notifies the output device controller 10 of the ID of the printer 20 stored in the ID storing section 210 (ID notification). The output device controller 10 further notifies the contents data supplying device 30 of the ID (ID notification). The contents data supplying device 30 buries the ID into the original contents data as a part of electronic watermarking information (Insertion of electronic watermark). The contents data supplying device 30 supplies the electronically watermarked contents data to the output device controller 10 (Supply of contents).

Particularly, in this embodiment, the contents data supplying device 30 (concretely, the charging information managing section 380) notifies the side of the output device controller 10 of the charging information responsive to the supplied contents data in accordance with search result of the data base (Notification of charging information).

Upon receiving the electronically watermarked contents data, the output device controller 10 carries out judging of ID, deformation of the contents, production of the printing data, and the like, and then outputs the printing data to the printer 20 (Output of printing data). The printer 20 carries out printing of the printing data The printer 20 investigates by itself whether or not the printing data have been completely printed. The printer 20 then notifies the output device controller 10 of the result of investigation as printing result information (Notification of printing result).

Besides, in FIG. 12, after the charging information have been notified to the side of the output device controller 10, the output device controller 10 carries out the above-mentioned judging of ID, and so on. However, any of those processing can be carried out faster than the others.

In the output device controller 10. obtaining of the charging information is carried out by the charging information obtaining section 190, collecting the charging information per each predetermined period is carried out by the charging money accounting section 192, and the electronic settlement is carried out by the electronic settlement section 194, respectively. As a result, settlement information obtained at the last are notified to the charging information managing section 380 at the side of the contents data supplying device 30 (Notification of settlement information).

Herein, also in this embodiment, it is desirable that information transferred between the devices are coded in a word adequately similarly to the first and the second embodiments. Further, it is desirable that the contents of the processing internally conducted in each of the output device controller 10, the printer 20, and the contents data supplying device 30 can be prevented from being known or altered by an user. For this purpose, it is desirable that the program for the processing is rendered to be difficult to read by the use of tamper-registering method.

Besides, in the above-mentioned third embodiment, an example of variation to have the charging information managing section 380, the charging information obtaining section 190, the charging money accounting section 192, and the electronic settlement section 194 is described based on the structures of the output device controller 10 and the contents data supplying device 30 illustrated in FIGS. 3 and 5 However, the output device controller 10 may have those sections based on the structure illustrated in FIG. 4. On the other hand, the contents data supplying device 30 may have those sections based on the structure illustrated in FIG. 6.

As described above, according to the method of supplying contents data and the contents data supplying system of the present invention, contents data can be supplied on a condition that an output device capable of outputting the contents data fairly is specified at the time of supplying the contents data. Copy right of contents can be protected more effectively.

What is claimed is:

1. A method of supplying contents data. said method comprising the steps of:
firstly storing original contents data for original contents;
secondly requesting a user who hopes a supply of said original contents data to input ID of an output device owned by the user;
thirdly inserting electronic watermarking information including said ID inputted by the user into said original contents data to produce electronically watermarked contents data in accordance with a predetermined electronic watermarking method capable of being handled by an output device controller owned by the user; and
fourthly supplying the user with said electronically watermarked contents data.

2. A method as claimed in claim 1, wherein said electronic watermarking information inserted in the thirdly inserting step are a visible mark formed on said original contents.

3. A method as claimed in claim 2, wherein said original contents data are image data.

4. A method as claimed in claim 1, wherein said output device is a printer and said original contents data are data capable of being printed.

5. A method as claimed in claim 1, wherein said fourthly supplying step is carried out by transmitting said electronically watermarked contents data to said user through a network.

6. A method as claimed in claim 1, wherein said fourthly supplying step is carried out by storing said electronically watermarked contents data in a storing medium prepared by said user.

7. A method as claimed in claim 1, further comprising the step of conducting admittance processing using an electronic signature with said user to produce a common key co-owned with said user, wherein said fourthly supplying step is carried out by supplying said electronically watermarked contents data coded by said common key.

8. A method as claimed in claim 1, further comprising the steps of:
previously storing a fee for using said original contents data, said fee being related to the original contents data;
obtaining said fee related to said original contents data of which said user hopes a supply; and
notifying said user of the obtained fee.

9. A contents data supplying device comprising:
a storing section which stores original contents data for original contents;
an ID obtaining section which obtains ID of an output device owned by a user who hopes a supply of said original contents data;
an electronic watermark inserting section which inserts electronic watermarking information including said ID obtained by said ID obtaining section into said original contents data to produce electronically watermarked contents data in accordance with a predetermined electronic watermarking method capable of being handled by an output device controller owned by the user; and
a supplying section which supplies the user with said electronically watermarked contents data.

10. A contents data supplying device as claimed in claim 9, wherein said electronic watermarking information inserted by said electronic watermark inserting section are a visible mark formed on said original contents.

11. A contents data supplying device as claimed in claim 9, wherein said original contents data are image data.

12. A contents data supplying device as claimed in claim 9, wherein said output device is a printer and said original contents data are data capable of being printed.

13. A contents data supplying device as claimed in claim 9, wherein both said ID obtaining section and said supplying section are connected with a network to which said output device controller owned by the user is also connected, said ID obtaining section obtaining the ID through said network while said supplying section supplying the user with said electronically watermarked contents data also through said network.

14. A contents data supplying device as claimed in claim 9, wherein said ID obtaining section is capable of reading information stored in a first storing medium, said ID obtaining section obtaining said ID by reading the ID from said first storing medium which is owned by said user and in which said ID has been previously stored, and wherein said supplying section is capable of writing information into a second storing medium, said supplying section supplying said user with said electronically watermarked contents data by writing the electronically watermarked contents data into said second storing medium which is owned by said user.

15. A contents data supplying device as claimed in claim 9, said output device controller having first admittance section for conducting electronic admittance processing, wherein said contents data supplying device further comprises:
a second admittance section which conducts electronic admittance processing with said first admittance section and which produces a common key co-owned with said output device controller; and
a coding section which codes said electronically watermarked contents data produced by said electronic watermark inserting section in a word,
said supplying section supplying said user with the electronically watermarked contents data which are coded in a word by said coding section.

16. A contents data supplying device as claimed in claim 9, said storing section storing a fee for using said original contents data, said fee being related to the original contents data, wherein said contents data supplying device further comprises a charging information managing section which obtains said fee related to said original contents data that the user hopes from said storing section and which notifies the user of the obtained fee.

17. An output device controller for use on a condition that the output device controller is connected to an output device and a contents data supplying device, said output device having an ID thereof, said contents data supplying device inserting electronic watermarking information including said ID into said original contents data to produce electronically watermarked contents data in accordance with a predetermined electronic watermarking method, wherein said output device controller comprises:
an ID obtaining section which obtains said ID from said output device, which notifies said contents data supplying device of the obtained ID, and which holds the obtained ID;
a contents data obtaining section which obtains said electronically watermarked contents data from said contents data supplying device;
an electronic watermark extracting section which extracts electronic watermarking information from said electronically watermarked contents data obtained by said contents data obtaining section;
an ID judging section which compares a part of said electronic watermarking information extracted by said electronic watermark extracting section with said ID held by said ID obtaining section to judge whether or not both said part of said electronic watermarking information and said ID held by said ID obtaining section are identical with each other;
a contents data deforming section which deforms said electronically watermarked contents data to produce deformed contents data, when said ID judging section has judged that both said part of said electronic watermarking information and said ID held by said ID obtaining section be identical with each other; and
an output data producing section which produces output data capable of being handled by said output device from said deformed contents data.

18. An output device controller as claimed in claim 17, wherein said deformed contents data are said original contents data, said contents data deforming section deforming said electronically watermarked contents data by removing said electronic watermarking information therefrom to reproduce said original contents data.

19. An output device controller as claimed in claim 17, said contents data supplying device having first admittance section for conducting electronic admittance processing and being capable of coding said electronically watermarked contents data in a word by a predetermined key, wherein said output device controller further comprises:
a second admittance section which conducts electronic admittance processing with said first admittance section and which produces a common key co-owned with said contents data supplying device as said predetermined key; and
a decoding section which decodes said electronically watermarked contents data coded in a word by using said common key in said contents data supplying device and which outputs the decoded electronically watermarked contents data to said contents data obtaining section.

20. An output device controller for use on a condition that the output device controller is connected to an output device and a contents data supplying device, said output device having an ID thereof, said contents data supplying device inserting first electronic watermarking information partially including said ID into said original contents data to produce first electronically watermarked contents data in accordance with a predetermined electronic watermarking method, wherein said output device controller comprises:
an ID obtaining section which obtains said ID from said output device, which notifies said contents data supplying device of the obtained ID, and which temporarily holds the obtained ID;
a contents data obtaining section which obtains said first electronically watermarked contents data from said contents data supplying device;
an electronic watermark extracting section which extracts first electronic watermarking information from said first electronically watermarked contents data obtained by said contents data obtaining section;
an ID judging section which compares a part of said first electronic watermarking information extracted by said electronic watermark extracting section with said ID held by said ID obtaining section to judge whether or not both said part of said first electronic watermarking information and said ID held by said ID obtaining section are identical with each other;
a contents data deforming section which deforms said first electronically watermarked contents data to produce deformed contents data, when said ID judging section has judged that both said part of said first electronic watermarking information and said ID held by said ID obtaining section be identical with each other;
an electronic watermark inserting section at controller side which inserts second electronic watermarking information partially including said ID held by said ID obtaining section into said deformed contents data to produce second electronically watermarked contents data; and
an output data producing section which produces output data capable of being handled by said output device from said second electronically watermarked contents data.

21. An output device controller as claimed in claim 20, wherein said second electronic watermarking information inserted by said electronic watermark inserting section at controller side is an invisible mark formed on contents of said deformed contents data produced by said contents data deforming section.

22. An output device controller as claimed in claim 20, wherein said deformed contents data are said original contents data, said contents data deforming section deforming said first electronically watermarked contents data by removing said first electronic watermarking information therefrom to reproduce said original contents data.

23. An output device controller as claimed in claim 20, said contents data supplying device having first admittance section for conducting electronic admittance processing and being capable of coding said electronically watermarked contents data in a word by a predetermined key, wherein said output device controller further comprises:
a second admittance section which conducts electronic admittance processing with said first admittance section and which produces a common key co-owned with said contents data supplying device as said predetermined key; and
a decoding section which decodes said electronically watermarked contents data coded in a word by using said common key in said contents data supplying device and which outputs the decoded electronically watermarked contents data to said contents data obtaining section.
